(19) United States
(12) Patent Application Publication
(10) Pub. No.: US 2023/0085013 A1
(43) Pub. Date: Mar. 16, 2023

(54) MULTI-CHANNEL DECOMPOSITION AND HARMONIC SYNTHESIS

(71) Applicant: HEWLETT-PACKARD DEVELOPMENT COMPANY, L.P., Spring, TX (US)

(72) Inventor: Sunil Bharitkar, Palo Alto, CA (US)

(73) Assignee: HEWLETT-PACKARD DEVELOPMENT COMPANY, L.P., Spring, TX (US)

(21) Appl. No.: 17/795,193

(22) PCT Filed: Jan. 28, 2020
(86) PCT No.: PCT/US2020/015391

§ 371 Date: Jul. 25, 2022

(51) Int. Cl. G10L 19/008; H04S 3/00

(52) U.S. Cl. CPC G10L 19/008; H04S 3/006; H04S 2400/01

(57) ABSTRACT

In one example in accordance with the present disclosure, a system is described. The system includes a decompose device to decompose a multi-channel audio stream into at least a first portion and a second portion. A synthesis device of the system independently synthesizes harmonics in each of the first portion and the second portion using different harmonic models. An audio generator of the system combines synthesized harmonics from the first portion and the second portion with the multi-channel audio stream to generate a synthesized audio output.

### BACKGROUND

An audio output device receives an audio stream and generates an output that can be heard by a user. Examples of audio output devices include a speaker and a headphone jack for use with headphones or earbuds, or the like, to produce audio that can be heard by the user. A user may listen to various types of audio from the audio output device such as music, sound associated with a video, and the voice of another person (e.g., a voice transmitted in real time over a network). In some examples, the audio output device may be implemented in a computing device such as a desktop computer, an all-in-one computer, or a mobile device (e.g., a notebook, a tablet, a mobile phone, etc.).

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for multi-channel decomposition and harmonic synthesis, according to an example of the principles described herein.

FIG. 2 is a flow chart of a method for multi-channel decomposition and harmonic synthesis, according to an example of the principles described herein.

FIG. 3 is a diagram of a system for multi-channel decomposition and harmonic synthesis, according to an example of the principles described herein.

FIG. 4 is a block diagram of a first synthesizer of a system for multi-channel decomposition and harmonic synthesis, according to an example of the principles described herein.

FIG. 5 is a flow chart of a method for multi-channel decomposition and harmonic synthesis, according to an example of the principles described herein.

FIG. 6 depicts a non-transitory machine-readable storage medium for multi-channel decomposition and harmonic synthesis, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Audio output devices generate audio signals which can be heard by a user. Audio output devices may include speakers, headphone jacks, or other devices and may be implemented in any number of electronic devices. For example, audio output devices may be placed in electronic devices such as mobile phones, tablets, desktop computers, and laptop computers. In some examples, these electronic devices may be small to reduce weight and size, which may make the electronic device easier for a user to transport. However, such a reduction in size may reduce the capability of an associated audio output device. That is, small audio output devices may provide a poor frequency response at low frequencies.

As specific examples, the electro-mechanical speaker drivers in a small electronic device may be unable to move enough volume of air to produce low frequency tones at the volume that they exist in the original audio stream. Accordingly, the low frequency portions of an audio stream may be lost when the audio stream is played by these small electronic devices, thereby limiting the bandwidth of the reproduced audio stream. Similarly, a user may listen to audio by connecting ear buds or headphones to the electronic device, which electronic device may also be unable to accurately reproduce low frequency portions of the original audio stream.

As specific examples of the effects of the reduced capability of these devices, bandwidth limits incurred by an audio signal due to transducer (microphones or speakers) performance impact speech naturalness during voice communication (due to loss of fundamental frequency of male/female voice) and may interfere with natural language processing (NLP) for speech recognition. On the playback side, thin and small form-factor devices place an additional burden on the size of the speakers. Due to smaller drivers and less space, there may be no perceptible low-frequency playback, which can result in degraded audio quality and reduced sound-pressure level (loudness).

To compensate for the loss of low frequencies in the audio output device, the audio stream may be modified to create the perception of the low frequency component being present. In an example, harmonics of the low frequency signals may be added to the audio stream. The inclusion of the harmonics may create the perception in listeners that the low frequency is present even though the audio output device is unable to produce the low frequency. That is, the human brain and hearing system operate to fill in the low frequency when it is missing.

Accordingly, the present specification describes systems and methods that overcome this physical limitation by synthesizing the harmonic structure of the missing low frequency to trigger auditory decoding of the fundamental-frequency via harmonic spacing of the synthesized harmonics.

Specifically, the present specification describes systems and methods that use a hybrid approach for processing multi-channel audio streams which yields a stronger bass response. In a particular example, one harmonic model is used for a first portion of a multi-channel audio stream and another and different harmonic model is used for a second portion of the multi-channel audio stream. In a specific example, a multi-channel audio stream may be a surround sound audio stream, designated as a 5.1 signal which includes a left channel, a right channel, a center channel, a right-surround channel, a left-surround channel, and a low-frequency effects (LFE) channel, which may include low-pitched sounds in the range of 3 to 250 Hertz and which may be low-pass filtered. In this example, a first harmonic model is used for the LFE channel to synthesize harmonics, such as dominant frequency harmonics, from a narrow band signal of the LFE channel. A second harmonic model sums the low-passed version of a variety of the other channels and employs a different nonlinear harmonic model that is optimized for these wider band signals.

The mixed synthesized harmonics are then combined with the respective channel in the original audio stream to generate a perceptually bass-synthesized audio output. That is, this output is perceived as having these low frequencies present. While particular reference is made to a 5.1 audio stream, other audio streams such as 7.1 and other higher-order audio streams or object-based audio streams may be implemented in accordance with the principles described herein.

Specifically, the present specification describes a system. The system includes a filter to decompose a multi-channel audio stream into at least a first portion and a second portion. A synthesis device of the system independently synthesizes harmonics in each of the first portion and the second portion using different harmonic models. An audio generator of the system combines synthesized harmonics from the first portion and the second portion with the multi-channel audio stream to generate a synthesized audio output.

The present specification also describes a method. According to the method, a multi-channel audio stream is decomposed into at least a first portion and a second portion. Harmonics are synthesized in the first portion by applying a first harmonic model. Harmonics are synthesized in the second portion by applying a second harmonic model. The second harmonic model is different than the first harmonic model. Note that each harmonic may generate both even and odd harmonics. Synthesized harmonics are combined from the first portion and the second portion to the multi-channel audio stream to generate a synthesized audio output.

The present specification also describes a non-transitory machine-readable storage medium encoded with instructions executable by a processor. The machine-readable storage medium includes instructions to decompose a multi-channel audio stream into at least a first portion and a second portion, wherein the first portion includes a low-frequency effects (LFE) channel of a surround sound audio stream and the second portion includes non-LFE channels of the surround sound audio stream. The instructions are also executable by the processor to synthesize harmonics in the first portion by applying a first harmonic model and synthesize harmonics in the second portion by applying a second harmonic model, wherein the second harmonic model is different than the first harmonic model. The instructions are also executable by the processor to combine synthesized harmonics in the first portion with synthesized harmonics in the second portion and add combined synthesized harmonics to the multi-channel audio stream.

As used in the present specification and in the appended claims, the term “harmonic” refers to a signal having frequencies that are a positive integer multiple of an original, or fundamental, frequency. In the present specification, an example harmonic is a signal with a positive integer multiple of a frequency in the low-frequency effects channel which may be unreproducible by certain audio output devices.

Also as used in the present specification and in the appended claims, the term “audio output device,” refers to any device that converts an electronic representation of an audio stream to an audio output that is perceptible by humans. Examples of such devices include, speakers, ear buds, and headphones.

Such systems and methods 1) enhance low-frequency output of certain audio output devices; 2) avoid intermodulation distortion; and 3) can be implemented in a number of small electronic devices.

As used in the present specification and in the appended claims, the terms “decompose device,” “synthesis device,” “synthesizer,” “audio generator,” and “engine,” may refer to electronic components which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

As used in the present specification and in the appended claims, the term “machine-readable storage medium” refers to machine-readable storage medium that may be a tangible device that can retain and store the instructions for use by an instruction execution device. The machine-readable storage medium may be an electronic storage device, a magnetic storage device, an optical storage device, an electromagnetic storage device, a semiconductor storage device, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), and a memory stick.

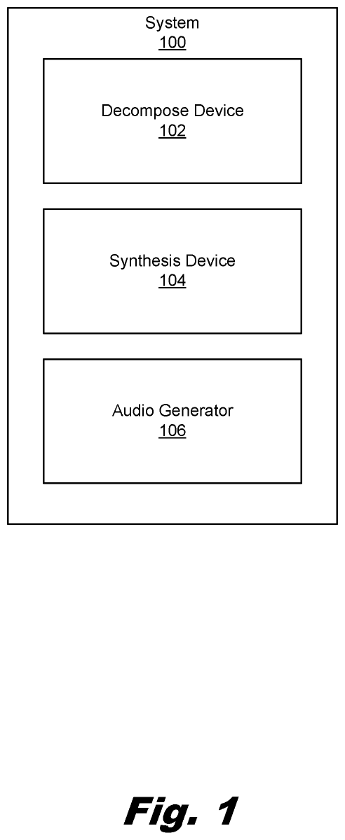

Turning now to the figures, FIG. 1 is a block diagram of a system (100) for multi-channel decomposition and harmonic synthesis, according to an example of the principles described herein. Specifically, the system (100) allows for the accurate replication of low-frequency output that may, for one reason or another, become lost when reproduced by certain audio output devices. For example, a motion picture may include a multi-channel audio stream that includes 5.1 or 7.1 channels where the designator 0.1 indicates the presence of a low-frequency effects (LFE) channel in the range of 3-250 Hz. This LFE channel reproduces low-pitched sound effects, for example those effects used to simulate the sound of an explosion, earthquake, or rocket launch. When reproduced on certain audio output devices, such as those included in small electronic devices such as tablets and mobile phones, this LFE audio information may become lost and un-reproduceable as a fundamental frequency. The system (100) generates harmonics of the dominant low frequency, such that the audio output device may replicate, or at least trigger replication of, the fundamental frequency in the listener's brain.

Accordingly, the system (100) includes a decompose device (102) to decompose a multi-channel audio stream into at least a first portion and a second portion. The first portion may be the low-frequency effects (LFE) channel of a surround sound audio stream and the second portion may include other, non-LFE channels. For example, the second portion may include a left channel, a right channel, a center channel, a left surround channel, and a right surround channel. While specific reference is made to particular other channels that are included in the second portion, additional channels may be included such as non-LFE channels in a 7.1 stream. In general, such a multi-channel audio stream is separated as channels and so the filter (102) may group certain channels into either of the first group or second group.

In an example, the decompose device (102) separates the multi-channel audio stream into mono channels based on metadata associated and received alongside the multi-channel signal, or from audio-channel ordering protocols such as an interleaving audio protocol from the Society of Motion Picture Television (SMPTE). For example, the multi-channel audio signal may include a signature or other metadata that identifies and distinguishes the different channels of the multi-channel signal. In this example, the decompose device (102) may read, interpret, and process the metadata to identify each of the channels and may de-interleave the channels and assign each channel to a respective portion.

The system (100) also includes a synthesis device (104) to independently synthesize harmonics in each of the first portion and the second portion using different harmonic models. In general, the synthesis device (104) expands a frequency range of a signal. In this example, the synthesis device (104) relies on the principle of the missing fundamental which suggests that a pitch heard is perceived based on the fundamental frequency rather than on the harmonics which may be present in the signal. Accordingly, by replicating the harmonics of the fundamental frequency, a listener will process these synthesized harmonics and perceive that the fundamental low-frequency is in fact found in the audio output.

In the present example, a first harmonic model may be used on the LFE channel while a second harmonic model may be used on the non-LFE channels. In this example, both the first harmonic model and the second harmonic model generate even and odd harmonics of the respective portions assigned to them. In some examples, at least one of the different harmonic models may be a non-linear model.

Using different models may enhance the replication of the missing low-frequency channels at output. For example, harmonics may be artificially produced by applying non-linear processing to the low frequency portion of an audio stream. However, if the span of the low frequency portion is too wide, has high signal levels, which could cause clipping, and/or the harmonic signals generated from using a broad frequency range cannot be reproduced in a loudspeaker due to loudspeaker driver excursion limitation, then the non-linear processing may cause audible distortion due to the creation of intermodulation distortion (IMD) that is added to the audio stream. IMD can take the form of third-order intermodulation products and beat notes. When the harmonics and IMD artifacts are added to the audio stream, the IMD may cause the resultant audio signal to have less clarity and sound “muddied.”

Accordingly, while such a technique may be used for non-LFE channels, this harmonic model when used on the LFE channel may reduce the quality of the output. Accordingly, a different harmonic model may be used for the LFE channel while the above described harmonic model may be used for non-LFE channels. Specifically, harmonic synthesis of the LFE channel may use dominant frequency identification. By comparison, harmonic synthesis of non-LFE channels may avoid considering dominant frequencies, but may rather use a bandpass filter (low-pass) to generate broad harmonics.

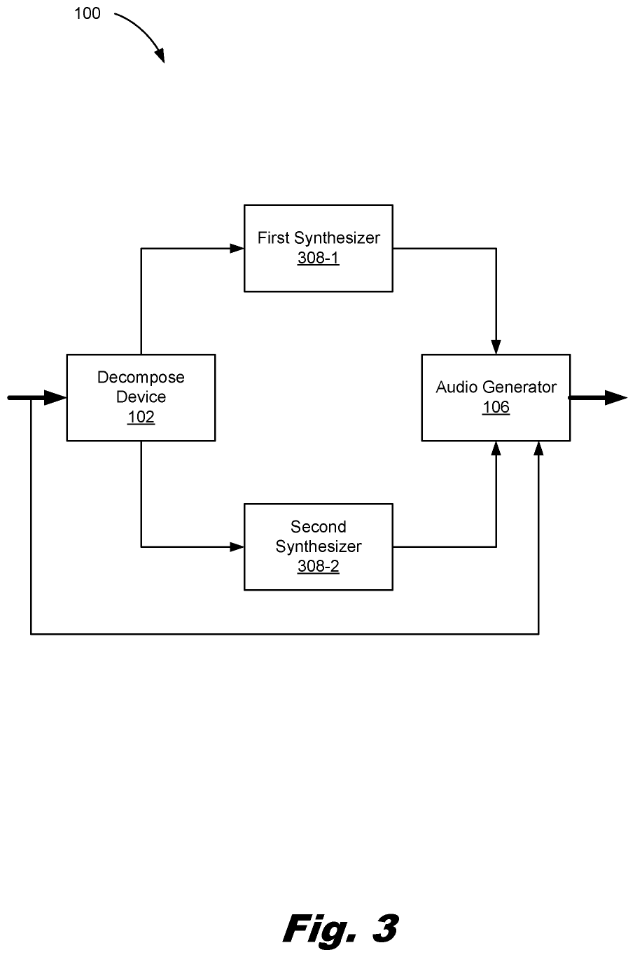

In some examples, such as that depicted in FIG. 3 below, the synthesis device (104) includes different synthesizers to process the different portions of the multi-channel audio stream. However, in other examples, the synthesis device (104) may include a single synthesizer that processes each of the portions of the multi-channel audio stream, either in series or simultaneously.

Moreover, while particular reference is made to generating harmonics for two distinct portions of the multi-channel audio stream, the synthesis device (104) may generate harmonics for each of multiple additional portions using different harmonic models. For example, the first portion may include the LFE channel of a surround sound audio stream, and each of remaining portions may include the different individual channels of the surround sound audio stream. Each of these additional portions may be processed by the same harmonic model, or different harmonic models to generate harmonics therefrom.

Once the different synthetic harmonics have been generated, an audio generator (106) combines synthesized harmonics from each of the first portion and the second portion with the multi-channel audio stream to generate a synthesized audio output. In some examples, the combination may rely on a scalar/gain factor or by using loudness masking models for each of the channels. The loudness masking may be based on the direction-dependent loudness masking as well for the non-LFE channels.

That is, the output audio may otherwise not include the fundamental frequency of the LFE channel. However, the synthesized harmonics can trigger in a listener's brain and hearing system the reproduction of these low-pitched sounds back into the audio stream. Thus, a synthesized audio output, while not including the low-frequency portion of the stream itself, includes harmonics of that low-frequency portion such that a listener's brain may interpolate to fill in and make it sound to the listener as if that low-frequency signal is in fact there. Moreover, by using multiple harmonic models, each of which are tailored to particular channels of a multi-channel stream, effects such as IMD are avoided, which increase the quality of the synthesized audio output.

The present system (100) may operate with better performance at lower audio frame-sizes as compared to single-mode harmonic generation systems which may implement longer audio frame sizes.

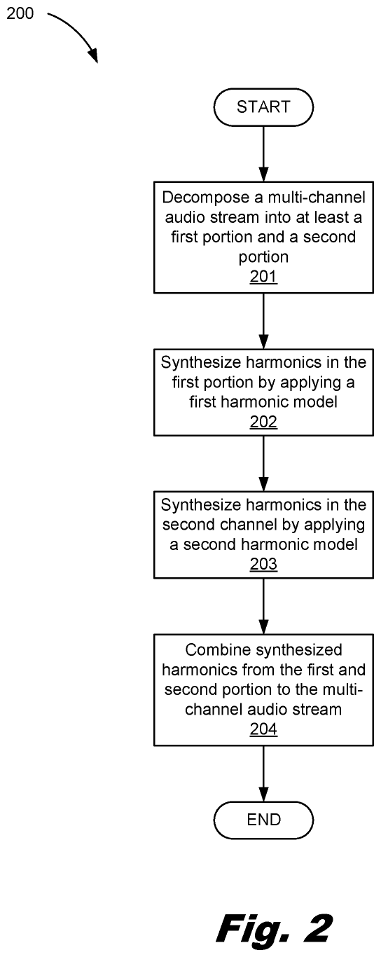

FIG. 2 is a flow chart of a method (200) for multi-channel decomposition and harmonic synthesis, according to an example of the principles described herein. According to the method (200), a multi-channel audio stream, such as a surround sound stream, is decomposed (block 201) into at least a first portion and a second portion. Note that the different portions may include different arrangements of the channels of the multi-channel audio signal. For example, the first portion may include an LFE channel and the second portion may include the other channels, such as the left, right, center, right-surround, left-surround, and other non-LFE channels. Such a separation of audio channels may be based on metadata associated and received alongside the multi-channel signal, or from audio-channel ordering protocols such as an interleaving audio protocol from the Society of Motion Picture Television (SMPTE). For example, the multi-channel audio signal may include a signature or other metadata that identifies and distinguishes the different channels of the multi-channel signal. In this example, the decompose device (FIG. 1, 102) may read, interpret, and process the metadata to identify each of the channels and may assign each channel to a respective portion.

Following this decomposition (block 201), harmonics may be synthesized (block 202) in the first portion by applying a first harmonic model. For example, as described above, the first portion may include an LFE channel which, if processed similarly to other non-LFE channels, may result in audio distortion. Accordingly, the LFE portion of the multi-channel stream may be processed in a particular fashion. Note, that in this example, both the even and odd harmonics of the first portion are synthesized (block 202). A particular example of the harmonic synthesis of a first, or LFE, portion of the multi-channel signal is now presented.

First, the synthesis device (FIG. 1, 104) may determine a maximum power sub-band in the LFE channel of an audio stream. This may be done by separating the lower frequency portion of the audio stream into sub-bands using an auditory filter bank, measuring the root-mean-square (RMS) power in each sub-band with a bank of detectors, and identifying the maximum power sub-band using a sub-band selection engine. The maximum power sub-band may be selected from the LFE portion of the audio stream. For example, the synthesis device (FIG. 1, 104) may synthesize a filter to extract the maximum power sub-band frequencies from the audio stream. Even and odd harmonics may be generated of the maximum power sub-band frequencies by applying the maximum power sub-band frequencies from the filter to a harmonic engine. The selection of a subset of the harmonics of the maximum power sub-band frequencies may also be made via filter synthesis. This subset may reflect those harmonics that are below the capabilities of the intended audio output device, and may be removed as they may have little effects in creating the perception of the dominant sub-band frequencies. This subset may be amplified by a parametric filter which may apply frequency selective gain shaping to the sub-set of harmonics. Other operations may be performed to synthesize (block 202) the harmonics in the first portion.

Using a different harmonic model, by the same non-linear device or another non-linear device, harmonics may be generated (block 203) in the second portion. Note, that as with the first harmonic model, in this example both the even and odd harmonics of the second portion are synthesized (block 203). That is, using a second harmonic model, which is different than the first harmonic model, even and odd harmonics of the low pitch sounds may be generated from the second portion of the multi-channel audio signal, which second portion may be that portion which includes the non-LFE channels. In some examples, the overall gain of the second harmonic generation may be controlled by the gain output of the first harmonic generation to control the relative gains so that the synthesized harmonics from either model may be combined in a particular way.

The synthesized harmonics from the first portion and the second portion are then combined (block 204) with the multi-channel audio stream to generate a synthesized audio output. That is, the LFE frequencies which may become lost in the output due to the characteristics of the audio output device, may be replicated at the listener due to the effects of the harmonics to create the perception of extended low-frequency by inserting the harmonics into the original audio stream.

In some examples, this combination (block 204) includes applying a relative gain to each grouping of harmonic models and adjusting the relative levels of harmonics generated in each portion. The adjusted synthesized harmonics may then be mixed back into the corresponding first or second portions at either a constant level or a frequency dependent level.

FIG. 3 is a diagram of a system (100) for multi-channel decomposition and harmonic synthesis, according to an example of the principles described herein. As described above, a multi-channel audio stream may be received at the system (100) where it first passes through a decompose device (102) that separates it into different portions. Once decomposed, the different portions are passed to the synthesis device (FIG. 1, 104). As depicted in FIG. 3, the synthesis device (FIG. 1, 104) may include a first synthesizer (308-1) to apply a first harmonic model to the first portion and a second synthesizer (308-2) to apply a second harmonic model to the second portion.

As described above, each of the synthesizers (308) may apply different harmonic models to the respective portions of the multi-channel stream based on characteristics of that portion. For example, the synthesis device (FIG. 1, 104), and specifically the first synthesizer (308-1) in this example, may generate harmonics of a dominant band of the LFE channel. Doing so may avoid the IMD that may result from otherwise processing the LFE channel.

The second synthesizer (308-2) which may operate on non-LFE channels may generate harmonics in a different fashion. In one particular example, the synthesis device (FIG. 1, 104), and specifically the second synthesizer (308-2), may generate harmonics from a summation of the channels in the second portion. That is, the audio signatures may be combined and harmonics created therefrom.

In another example, the synthesis device (FIG. 1, 104), and specifically the second synthesizer (308-2), may generate harmonics from each channel of the second portion individually. That is, rather than aggregate the different channels, the second synthesizer (308-2) may include secondary synthesizer modules each to generate harmonics for each of the channels found in the second portion. Note that as described above, each of the synthesizers (308-1, 308-2) generates both the even and odd harmonics for the respective portions.

In either example, the synthesized harmonics are passed to the audio generator (106) which also receives the original multi-channel audio stream. The audio generator (106) adds the synthesized harmonics to the original audio stream which generates an output that creates an auditory perception that those low pitch noises, while not actually included in the synthesized output, are nevertheless recreated in the listener's brain.

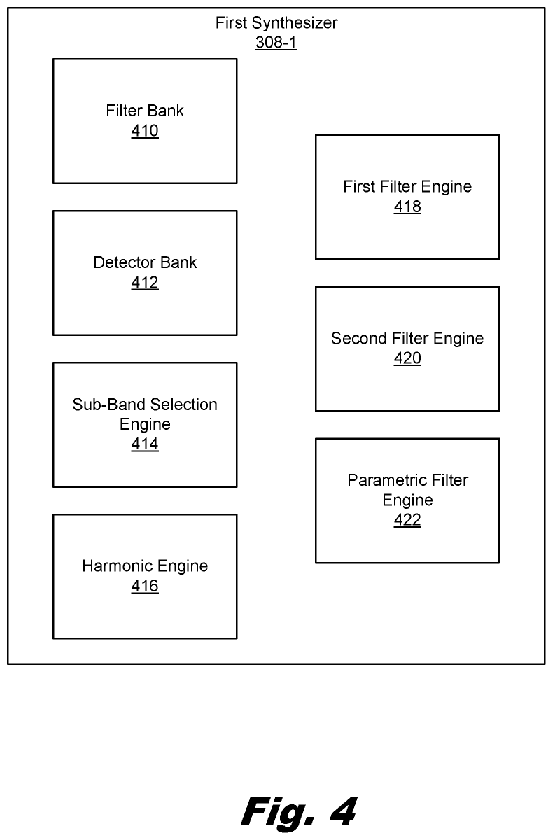

FIG. 4 is a block diagram of a first synthesizer (308-1) of a system (FIG. 1, 100) for multi-channel decomposition and harmonic synthesis, according to an example of the principles described herein.

As described above, a first portion, which includes an LFE channel, is received at the first synthesizer (308-1) which processes the LFE channel to generate synthesized harmonics which are used to create the perception of the LFE channel, even though such a channel may not actually be in an output. The first synthesizer (308-1) may include a filter bank (410) to separate the LFE channel into sub-bands. That is, the filter bank (410) includes auditory filters that span the low-frequency range, for example between 3 and 250 Hertz. The auditory filters may split the LFE channel into sub-band signals. In one example, the sub-band filters may include bandpass filters with overlapping cutoff frequencies. That is, the upper cutoff frequency of the nth sub-band filter (fnU) overlaps the lower cutoff frequency of the (n+1)th sub-band filter (f(n+1)L). In one example, the upper and lower cutoff frequencies may correspond to the 3-dB attenuation frequencies of the sub-band filters. In one example, the center frequency of each sub-band filter may have a sub-octave relationship with its adjacent filters, where the ratio of the center frequencies of two adjacent filters is a fractional power of 2, such as 21/3, 21/6, 21/12, 21/24, for example. Other types of filter banks that may be employed are the Equivalent Rectangular Bandwidth (ERB), Critical-bandwidth (CB), gammatone filter, etc. In one example, without limitation, the sub-band filters may be implemented in hardware, program code, or a combination of hardware and program code.

The first synthesizer (308-1) may also include a detector bank (412) to determine an audio power level of each sub-band. That is, the filter bank (410) separates the LFE channel into at least two sub-bands, each corresponding to one of the auditory filters in the filter bank (410). Each sub-band signal is received by a corresponding detector in the detector bank (412). In one example, detector bank (412) includes detectors to determine an audio power level in each of the at least two sub-bands. In one example, the power detectors may be RMS (root mean square) detectors. In other examples, the detectors may first compute the fast Fourier transform (FFT), then the log-magnitude to obtain a dB value in each sub-band, and then selecting the largest dB-valued sub-band.

The first synthesizer (308-1) may include a sub-band selection engine (414) to determine a dominant sub-band based on detected audio power levels. This may be done based on the maximum power detected by the detector bank (412) over a selected time period that corresponds to a frame of the audio stream. In one example, the sub-band selection engine (414) computes the RMS (root mean square) value of the output of each sub-band filter over a frame, and then selects the maximum RMS value as the dominant sub-band in that frame.

The first synthesizer (308-1) may include a harmonic engine (416) to generate harmonics of the dominant sub-band. The harmonic engine (416) may include a non-linear device that generates harmonics, including both even and odd harmonics of the dominant sub-band. For example, the harmonic engine (416) may apply non-linear processing to the dominant sub-band to generate the harmonics. The harmonics may include signals with frequencies that are integer multiples of the frequencies in the dominant sub-band.

In some examples, the first synthesizer (308-1) may include additional components such as a first filter engine (418) between the sub-band selection engine (414) and the harmonic engine (416). In this example, the first filter engine (418) removes frequency components other than those in the dominant sub-band. Accordingly, the harmonic engine (416) may produce less intermodulation distortion and beat notes than if a wide band filter or no filter had been applied. The harmonics engine (416) may produce a signal that includes the dominant sub-band frequencies and the harmonics.

In some examples, the first filter engine (418) synthesizes a bandpass filter corresponding to the dominant sub-band selected by the sub-band selection engine (414). The first filter engine (418) is coupled to the audio input stream. Accordingly, the first filter engine (418) operates to extract the dominant sub-band from the audio input stream and reject frequencies outside the dominant sub-band.

Specifically, the first filter engine (418) may be notified by the sub-band selection engine (414) of the dominant sub-band in the current frame. In turn, the first filter engine (418) synthesizes a filter, referred to as a first filter, to replicate the sub-band filter corresponding to the dominant sub-band. In one example, the first filter may be a duplicate of the corresponding sub-band filter, or some variation corresponding to a critical band of an auditory filter.

As used herein, the term “auditory filter” refers to any filter from a set of contiguous filters that can be used to model the response of the basilar membrane to sound. The basilar membrane, part of the human hearing system, is a pseudo-resonant structure that, like strings on an instrument, varies in width and stiffness. The “string” of the basilar membrane is not a set of parallel strings, as in a guitar, but a long structure that has different properties (width, stiffness, mass, damping, and the dimensions of the ducts that it couples to) at different points along its length. The motion of the basilar membrane is generally described as a traveling wave. The parameters of the membrane at a given point along its length determine its characteristic frequency, the frequency at which it is most sensitive to sound vibrations. The basilar membrane is widest and least stiff at the apex of the cochlea, and narrowest and most stiff at the base. High-frequency sounds localize near the base of the cochlea (near the round and oval windows), while low-frequency sounds localize near the apex.

As used herein, the term “critical band” refers to the passband of a particular auditory filter. In an example, the first filter corresponds to an auditory filter with a center frequency closest to the center frequency of the dominant sub-band. The filter of the first filter engine may load predetermined filter coefficients. In one example, the first filter may be a minimum phase IIP or FIR filter.

In one example, the first filter engine (418) may pass frequencies in the dominant sub-band from the audio input stream, and attenuate or reject all other frequencies in the audio input stream. In one example, the first filter engine (418) may include an input buffer or delay to compensate for the filtering, detection, selection and synthesis processes described herein, which has a finite amount of processing time.

As an additional example of an additional component, the first synthesizer (308-1) may include a second filter engine (420) coupled to the harmonic engine (416), to select a subset of the harmonics generated by the harmonic engine (416), where the selected subset of harmonics of the dominant sub-band are used to create the perception of low frequency content in an audio stream.

Specifically, the second filter engine (420) may receive parameters from the first filter engine (418), wherein the second filter engine (420) can synthesize a second filter to pass a subset of the harmonics. Frequencies in the dominant sub-band and some of the lower-order harmonics in the harmonics may be at frequencies that the audio output device cannot reproduce, so the second filter engine (420) may synthesis a second filter to remove those frequencies.

Also, higher-order harmonics above a predetermined upper frequency limit may have little effects in creating the perception of the dominant sub-band, so the second filter engine (420) may remove the higher-order harmonics as well. In some examples, the second filter engine (420) may keep some or all of the second harmonic, third harmonic, fourth harmonic, fifth harmonic, sixth harmonic, seventh harmonic, eighth harmonic, ninth harmonic, tenth harmonic, etc. The second filter engine (420) may output a signal that includes the subset of harmonics. In one example, the second filter engine (420) may include an input buffer or delay to compensate for signal processing delays associated with synthesizing the second filter engine (420). In one example, the second filter engine may include a filter that is a minimum phase filter IIR or FIR filter.

The second filter may have a lower cutoff frequency and an upper cutoff frequency. As used herein, the term “cutoff frequency” refers to a frequency at which signals are attenuated by a particular amount (e.g., 3 dB, 6 dB, 10 dB, etc.) The second filter may select the cutoff frequencies based on the first filter, which may have its own lower and upper cutoff frequencies. The lower cutoff frequency of the second filter may be selected to be a first integer multiple of the lower cutoff frequency of the first filter, and the upper cutoff frequency of the second filter may be selected to be a second integer multiple of the upper cutoff frequency of the first filter. The first and second integers may be different from each other. The first and second integers may be selected so that the lower cutoff frequency of the second filter excludes harmonics below the capabilities of the audio output device and the upper cutoff frequency of the second filter excludes harmonics that have little effects in creating the perception of the dominant sub-band. In one example, the first integer may be two, three, four, five, six, or the like, and the second integer may be three, four, five, six, seven, eight, nine, ten, or the like.

Yet another component that the first synthesizer (308-1) may include is a parametric filter engine (422). The parametric filter engine (422) may apply a gain to the subset of harmonics received from the second filter by applying a parametric filter to the signal to shape the spectrum of the signal in order to maximize the psycho-acoustic perception of the missing fundamental frequencies. The parametric filter engine (422) may receive an indication of the gains to apply to different segments of the spectrum from a gain engine and an indication of the lower and upper cutoff frequencies of the second filter from the second filter. The parametric filter engine (422) may synthesize the parametric filter based on the gain and the cutoff frequencies of the second filter. In one example, without limitation, the parametric filter may be a biquad filter (i.e., a second-order IIR filter). In some examples, gain may be applied to the signal containing the subset of harmonics without using a parametric filter, e.g., using an amplifier to apply a uniform gain to the signal containing the subset of harmonics.

As described above, the generated harmonics may be added to the audio stream. Before so doing, the input audio stream may pass through a high-pass filter and a delay engine of the first synthesizer (308-1). In one example, the high-pass filter removes the low frequency component of the audio input stream that cannot be reproduced by the audio output device. The delay engine brings the remaining high frequency components of the filtered audio input stream (those which the audio output device can reproduce) into time alignment with the amplified set of harmonics which have been delayed by the signal processing described above.

For example, some or all of the engines, such as sub-band selection engine (414), first filter engine (418), harmonic engine (416), second filter engine (420), and parametric filter engine (422) may delay the amplified subset of harmonics relative to the audio input stream. Accordingly, the delay engine may delay the filtered audio input stream to ensure it will be time-aligned with the amplified subset of the harmonics when the filtered audio input stream and the amplified subset of harmonics.

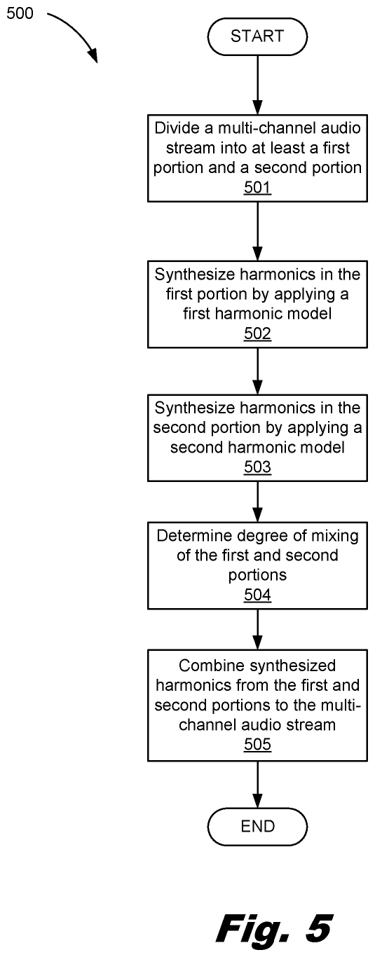

FIG. 5 is a flow chart of a method (500) for multi-channel decomposition and harmonic synthesis, according to an example of the principles described herein. As described above, a multi-channel audio stream is divided (block 501) into a first portion and a second portion, with harmonics being synthesized (block 502) in the first portion via a first harmonic model and harmonics being synthesized (block 503) in the second portion via a second harmonic model. These operations may be performed as described above in connection with FIG. 2.

As described above, the synthesized harmonics may then be added back into the audio stream. This may include combining synthesized harmonics from the first portion with the first portion and combining the synthesized harmonics from the second portion with the second portion. The first and second portion may then be mixed together. The degree to which these harmonics are mixed with one another may be selectable. Accordingly, the method (500) includes determining (block 504) a degree of mixing of the portions. The degree of mixing may be based on a desired output. For example, if it is desired that the low-pitch sound effects such as explosions, jet engines, etc. are desired to be particularly prevalent, a gain may be adjusted towards the first, or LFE, portion of the divided audio stream. By comparison, if a more balanced audio is desired, such as to highlight spoken language, the gain may be adjusted towards the second, or non-LFE portion of the divided audio stream. In some examples the degree of mixing may be determined (block 504) automatically. In other examples, the degree of mixing may be determined (block 504) based on user input. Accordingly, a user interface may be presented to receive indication, from a user, of a degree to which the first portion, with its synthesized harmonics, are combined, or mixed, with the second portion, with its synthesized harmonics.

The combined portions may then be combined (block 505) to the multi-channel audio signal. This operation may be performed as described above in connection with FIG. 2.

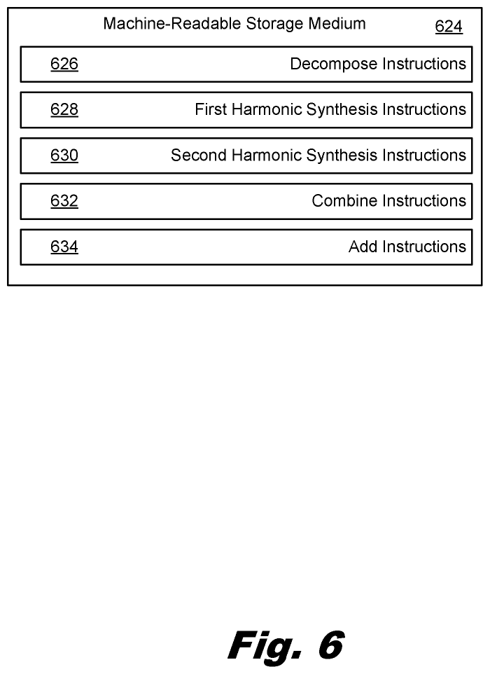

FIG. 6 depicts a non-transitory machine-readable storage medium (624) for multi-channel decomposition and harmonic synthesis, according to an example of the principles described herein. To achieve its desired functionality, a computing system includes various hardware components. Specifically, a computing system includes a processor and a machine-readable storage medium (624). The machine-readable storage medium (624) is communicatively coupled to the processor. The machine-readable storage medium (624) includes a number of instructions (626, 628, 630, 632, 634) for performing a designated function. The machine-readable storage medium (624) causes the processor to execute the designated function of the instructions (626, 628, 630, 632, 634).

Referring to FIG. 6, decompose instructions (626), when executed by the processor, cause the processor to decompose a multi-channel audio stream into at least a first portion and a second portion, the first portion including a low-frequency effects (LFE) channel of a surround sound audio stream and the second portion including non-LFE channels of the surround sound audio stream. First harmonic synthesis instructions (628), when executed by the processor, may cause the processor to, synthesize harmonics in the first portion by applying a first harmonic model. Second harmonic synthesis instructions (630), when executed by the processor, may cause the processor to, synthesize harmonics in the second portion by applying a second harmonic model.

Combine instructions (632), when executed by the processor, may cause the processor to combine synthesized harmonics in the first portion with synthesized harmonics in the second portion. Add instructions (634), when executed by the processor, may cause the processor to add combined synthesized harmonics to the multi-channel audio stream.

Such systems and methods 1) enhance low-frequency output of certain audio output devices; 2) avoid intermodulation distortion; and 3) can be implemented in a number of small electronic devices.

What is claimed is:

1. A system, comprising:
a decompose device to decompose a multi-channel audio stream into at least a first portion and a second portion;
a synthesis device to independently synthesize harmonics in each of the first portion and the second portion using different harmonic models; and
an audio generator to combine synthesized harmonics from the first portion and the second portion with the multi-channel audio stream to generate a synthesized audio output.

2. The system of claim 1, wherein:
the first portion comprises a low-frequency effects channel; and
the second portion comprises other channels of the multi-channel audio stream.

3. The system of claim 2, wherein:
the multi-channel audio stream is a surround sound audio stream; and
the second portion comprises at least:
a left channel;
a right channel;
a center channel;
a left surround channel; and
a right surround channel.

4. The method of claim 2, wherein the synthesis device is to generate harmonics of a dominant band of the low-frequency effects channel.

5. The method of claim 2, wherein the synthesis device is to generate harmonics from a summation of channels in the second portion.

6. The method of claim 2, wherein the synthesis device is to generate harmonics from each of the channels in the second portion.

7. The system of claim 1, wherein the synthesis device is to synthesize harmonics in each of multiple additional portions using different harmonic models.

8. The system of claim 1, wherein at least one of the different harmonic models is a non-linear model.

9. The system of claim 1, wherein the synthesis device comprises:
a first synthesizer to apply a first harmonic model to the first portion; and
a second synthesizer to apply a second harmonic model to the second portion.

10. The system of claim 9, wherein the first synthesizer comprises:
a filter bank to separate a low-frequency effects channel into sub-bands;
a detector bank to determine an audio power level of each sub-band;
a sub-band selection engine to determine a dominant sub-band based on detected audio power levels;
a first filter engine to remove frequency components outside the dominant sub-band;
a harmonic engine to generate harmonics of the dominant sub-band;
a second filter engine to select a subset of harmonics generated by the harmonic engine; and
a parametric filter engine to apply a parametric filter to the subset.

11. A method, comprising:
decomposing a multi-channel audio stream into at least a first portion and a second portion;
synthesizing harmonics in the first portion by applying a first harmonic model;
synthesizing harmonics in the second portion by applying a second harmonic model, wherein the second harmonic model is different than the first harmonic model; and
combining synthesized harmonics from the first portion and the second portion to the multi-channel audio stream to generate a synthesized audio output.

12. The method of claim 11, further comprising combining the first portion with the second portion.

13. The method of claim 12, wherein a degree to which the first portion and second portion are mixed is based on user input.

14. A non-transitory machine-readable storage medium encoded with instructions executable by a processor, the machine-readable storage medium comprising instructions to:
decompose a multi-channel audio stream into at least a first portion and a second portion, wherein:
the first portion comprises a low-frequency effects (LFE) channel of a surround sound audio stream; and
the second portion comprises non-LFE channels of the surround sound audio stream;
synthesize harmonics in the first portion by applying a first harmonic model;
synthesize harmonics in the second portion by applying a second harmonic model, wherein the second harmonic model is different than the first harmonic model;
combine the first portion with the second portion; and
add combined synthesized harmonics to the multi-channel audio stream.

15. The non-transitory machine-readable storage medium of claim 14, further comprising instructions to present a user interface to receive indication of a degree to which the synthesized harmonics in the first portion are combined with synthesized harmonics in the second portion.
